(19) United States
(12) Patent Application Publication
(10) Pub. No.: US 2026/0367301 A1
(43) Pub. Date: Nov. 19, 2026

(54) COMPOSITE PANE

(71) Applicant: AGC GLASS EUROPE, Louvain-la-Neuve (BE)

(72) Inventors: Charlie DE BECKER, Gosselies (BE); Kadosa HEVESI, Gosselies (BE)

(73) Assignee: AGC GLASS EUROPE, Louvain-la-Neuve (BE)

(21) Appl. No.: 19/476,041

(22) PCT Filed: Jul. 1, 2024
(86) PCT No.: PCT/EP2024/068455

§ 371 Date: Oct. 16, 2025

(30) Foreign Application Priority Data
Jul. 4, 2023 (EP) 23183289

(51) Int. Cl. G02B 5/20; B32B 7/023; B32B 17/10; B60J 1/00; C03C 17/36; G02B 5/26

(52) U.S. Cl. CPC G02B 5/208; B32B 7/023; B32B 17/10036; B32B 17/10229; B60J 1/001; C03C 17/3644; C03C 17/3649; C03C 17/366; G02B 5/26; B32B 2307/40; B32B 2307/7376; B32B 2605/00; C03C 2217/212; C03C 2217/213; C03C 2217/216; C03C 2217/23; C03C 2217/256; C03C 2217/258; C03C 2217/948

(57) ABSTRACT

A composite pane having two glass panes, each with an outer-side and interior-side surface, and a thermoplastic interlayer. The composite pane also has an IR reflective coating and low emissivity coating. The composite pane may be used as a window pane for a vehicle.

The invention relates to a composite pane having IR reflective coating and low emissivity coating, to a method to provide for said pane and to uses thereof.

Composite panes having sun protection are known in the art.

WO2019/110172 relates to a composite pane, comprising: an outer pane (1), which has an outer surface (I) and an interior-side surface (II); an inner pane (2), which has an outer surface (III) and an interior-side surface (IV); and a thermoplastic interlayer (3), which connects the interior-side surface (II) of the outer pane (1) to the outer surface (III) of the inner pane (2), the composite pane having at least one sun protection coating (4) between the outer pane (1) and the inner pane (2), which sun protection coating reflects or absorbs mainly radiation outside of the visible spectrum of the solar radiation, in particular infrared radiation, and the composite pane having, on the interior-side surface (IV) of the inner pane (2), a thermal-radiation-reflecting coating (5) (low-E coating), characterized in that the composite pane has a transmittance index A of 0.02 to 0.08, the transmittance index A being determined according to the following formula (I): A=TL_{composite glass pane/(TLlow-E-coated pane*TE)} (I), TL being the light transmittance and TE being the energy transmission measured according to ISO 9050. The goal was to have the lowest possible TTS value (measure of the total transmitted heat radiation of the sun through the pane, and for example according to the ISO 9050) in combination with a light transmission of 2 to 10% in order to ensure the best possible compromise between the view through the roof to the outside and good thermal properties.

WO2005007592A2 discloses a vehicle glazing comprising a pane of tinted glass, tinted by at least 1.0 to 1.8% wt. of total iron, having a low emissivity coating on its interior surface. The coating has an emissivity from 0.05 to 0.4 and may include a transparent conductive oxide (and optionally a dopant), or a metal layer and at least one dielectric layer. Also disclosed is a laminated glazing comprising two plies of glass, laminated by a sheet of interlayer material therebetween, wherein at least one ply of glass or the sheet of interlayer material is body tinted, said glazing having a low emissivity coating on its interior surface. The inner ply may be clear glass or tinted glass. The interlayer material may be clear PVB or tinted PVB, and it may further be infra-red reflecting. Either of the glazings may be used as a roof or other vehicle glazing.

EP2090428A1 relates to a glazing with high thermal performance for a vehicle, in particular for a roof of a motor vehicle, and this new glazing is a laminated glazing consisting of an outer glass, a inner glass, an interlayer between the two glasses consisting of at least one absorbent PVB-based film, the inner glass being coated on its inner side with a low-emissivity layer. The optimal solution preferred in EP2090428A1 is the use of a tinted outer glass, and a clear inner glass as a support for the low emissivity layer.

WO2016202799A1 relates to a laminated glazing comprising a substrate, in particular a transparent substrate, optionally coloured, coated with an infrared-reflecting layer and capable of being used as glazing in buildings or in vehicles. The coated substrate is made up of the combination of a glass substrate in which the composition has a redox of less than 15%, characterised by infrared reflection RIRV so that RIRV≥1.087*TLV, wherein TLV is the light transmission of the glass, and an infrared reflecting layer characterised by light transmission TLC so that TLC≥1.3*TIRC, wherein TIRC is the infrared transmission of the layer.

Glazings intended for use in sunroofs and sliding roofs require light transmittance between 2 and 10% and specific sun protection. For the visual comfort of occupants, the reflection of light is targeted at less than 10%, preferably less than 8%. For the thermal comfort of occupants, a low total transmitted heat radiation (TTS) is desired, less than 35%.

The objective is, consequently, to provide for a composite pane with current requirements in terms of thermal management, light management, low reflection inside and low reflection outside.

### Objective

The composite pane therefore is targeted to possess the following characteristics:
a light transmittance Tvis of 1 to 10%, preferably of 1 to 8%, in order to ensure the best possible compromise between vision outside through the roof and good thermal properties;
a light reflectance observed from the outside Rout≤9%;
a light reflectance observed from the inside Rin≤10%;
a total transmitted heat radiation (TTS)≤22%, preferably ≤16%, (measured according to ISO 9050).

This object is accomplished according to the invention by a composite pane comprising
a. a first glass pane having an outer-side surface and an interior-side surface, characterized by a infrared transmission T_{IR}>60% (in the wavelengths of 780-2500 nm) and a visible transmission Tᵥᵢₛ<10%, alternatively ≤6% (in the wavelengths of 380-780 nm), and a ratio Tᵥᵢₛ/T_{IR}<0.20, for a glass sheet of 4 mm thickness;
b. a second glass pane having an outer-side surface and an interior-side surface, different from the first glass pane, characterized by a ratio Tᵥᵢₛ/T_{IR}>0.50, and by a ratio Tᵥᵢₛ/TE>0.70, for a glass sheet of 4 mm thickness (with T_{IR} considered in the wavelengths of 780-2500 nm, and Tᵥᵢₛ considered in the wavelengths of 380-780 nm, and TE considered in the wavelength range of 300-2500 nm); and
c. a thermoplastic interlayer that joins the interior-side surface of the outer pane to the outer-side surface of the inner pane,
   wherein the composite pane comprises, between the outer pane and the inner pane, at least one infrared reflective coating.

In the scope of the present invention, the opto-energetical properties of the first and second panes are considered herein as intrinsic properties of said panes, and not as objectives in themselves. The proper selection of said first and second panes allows for the final composite pane to reach the targets in terms of light transmittance, light reflectance observed from the outside, a light reflectance observed from the inside and total transmitted heat radiation.

In the scope of the present invention, the assessment of the performances and values was carried out according to automotive reference ISO9050, under Illuminant A, at a 2° observer:
Tᵥᵢₛ (%): light transmittance in the visible range of 380-780 nm
T_{IR} (%): infrared transmittance in the infrared range of 780-2500 nm
TE (%); energy transmittance in the wavelength range of 300-2500 nm
TTS (%): total transmitted heat radiation in the wavelength range of 300-2500 nm.
Rout (%): light reflectance to the outside in the visible range of 380-780 nm
Rin (%): light reflectance to the inside in the visible range of 380-780 nm

The composite pane is intended, in a window opening, to separate an interior space from the external environment, in particular the interior of a vehicle or of a room. The composite pane is a laminate and comprises a first pane and a second pane that are joined to one another via a thermoplastic interlayer.

In the context of the invention the “inner pane” is the pane that faces the interior in the installed position. “Outer pane” refers to the pane facing the external environment in the installed position. “Interior-side surface (or inside or inner surface)” means, in the context of the invention, that surface of the panes that faces the interior in the installed position. “Outer-side surface (outside or outer surface)” means, in the context of the invention, that surface of the panes that faces the external environment in the installed position.

In the scope of the present invention, the first and second glass panes may be either one of the inner or outer pane respectively, that is, when the first glass pane is the outer pane, then the second pane consequently is the inner glass pane, and when the first glass pane is the inner pane, then the second pane consequently is the outer glass pane.

The surfaces of the panes are typically referenced as follows. The outer side of the outer pane is referred to as side 1. The inner-side of the outer pane is referred to as side 2. The outer side of the inner pane is referred to as side 3. The inner-side of the inner pane is referred to as side 4. The interior-side surface of the outer pane and the outer-side surface of the inner pane face one another and are bonded to one another by means of the thermoplastic interlayer.

The first pane having an outer-side surface and an interior-side surface, may be characterized by an infrared transmission T_{IR}>60% (in the wavelengths of 780-2500 nm) and a visible transmission Tᵥᵢₛ<10%, alternatively ≤6% (in the wavelengths of 380-780 nm), and a ratio Tᵥᵢₛ/T_{IR}<0.20, for a glass sheet of 4 mm thickness.

The ratio Tᵥᵢₛ/T_{IR} of the first glass pane may preferably be <0.15; more preferably <0, 10; most preferably <0.06.

The infrared wavelength typically ranges of from 780 nm to more than 10 micrometers. However, the use of infrared technologies is typically processed at wavelengths in the near-infrared, that is, that range of the wavelength nearest to the visible wavelength, border to the red, namely ranging of from 780-2500 nm.

In the scope of the present invention, the terms “infrared rays”, “infrared light” and “infrared wavelengths” may be used interchangeably and encompass the same wavelength region ranging of from 780-2500 nm.

The first glass types will be herein referred to as “infrared transmissive glass”, and are typically those having an absorption coefficient lower than 25 m⁻¹ in the wavelength range from 750 to 1650 nm. To quantify the low absorption of the first glass sheet in the infrared range, in the present description, the absorption coefficient is used in the wavelength range from 750 to 1650 nm.

The absorption coefficient is defined by the ratio between the absorbance and the optical path length traversed by electromagnetic radiation in a given environment. It is expressed in m-1. It is independent of the thickness of the material but it is function of the wavelength of the absorbed radiation and the chemical nature of the material.

The absorption coefficient (μ) at a chosen wavelength λ can be calculated from a measurement in transmission (T) as well as the refractive index n of the material (thick=thickness), the values of n, ρ and T being a function of the chosen wavelength λ:

$$μ = - \frac{1}{thick} \cdot ln [ \frac{- {( 1 - ρ )}^{2} + \sqrt{{( 1 - ρ )}^{4} + 4 \cdot {T}^{2} \cdot {ρ}^{2}}}{2 \cdot T \cdot {ρ}^{2}} ]$$

$$where ρ = {( n - 1 )}^{2} / {( n + 1 )}^{2} .$$

The first glass sheet type according to the invention preferably has an absorption coefficient<25 m⁻¹, in the wavelength range of 750-1650 nm.

In some instances the glass may be colored glass, from green, blue or grey, up to black glass, provided the glass is transmissive for infrared rays of from 780 to 2500 nm.

Conventional “clear glass” typically has an absorption coefficient about 30 m⁻¹ order, significantly higher than the present preferred glass types.

Different compositions of glass may be suitable in the scope of the present invention, provided the absorption<25 m⁻¹, the wavelength range from 750 to 1650 nm.

The base first glass composition of the invention may comprise a total content expressed in weight percentages of glass:
SiO2 55—85%
Al2O30—30%
B2O3 0—20%
Na2O 0—25%
CaO0—20%
MgO 0—15%
K2O 0—20%
BaO 0—20%.

Alternatively, the base first glass composition may comprise a total content expressed in weight percentages of glass:
SiO2 55—78%
Al2O30—18%
B2O30—18%
Na2O 0—20%
CaO0—15%
MgO 0—10%
K2O 0—10%
BaO 0—5%.

Alternatively, the base first glass composition may comprise a total content expressed in weight percentages of glass:
SiO2 60—75%
Al2O30—6%
B2O30—4%
CaO0—15%
MgO 0—10%
Na2O 5—20%
K2O 0—10%
BaO 0—5%.

In addition to its basic composition, the first glass pane may include other components according to the desired effect. In the scope of the present invention, a very transparent glass in the high infrared (IR), with weak or no impact on its aesthetic or its color, may be obtained by combining a low iron quantity and chromium in a range of specific contents in the glass composition.

The glass sheet composition may thus comprise a content, expressed as the total weight of glass percentages, of
Fe total (expressed as Fe₂O₃) in amounts of 0,002 to 0.06% and Cr₂O₃ in amounts of 0,0001 to 0.06%; or
Fe total (expressed as Fe₂O₃) in amounts of 0,002 to 0.06% and Cr₂O₃ in amounts of 0.0015 to 1% and Co in amounts of 0,0001 to 1%; or
Fe total (expressed as Fe₂O₃) in amounts of 0.02 to 1% and Cr₂O₃ in amounts of 0,002 to 0.5% and Co in amounts of 0,0001 to 0.5%; or
Fe total (expressed as Fe₂O₃) in amounts of 0,002 to 1% and Cr₂O₃ in amounts of 0.001 to 0.5% and Co in amounts of 0,0001 to 0.5% and Se in amounts of 0,0003 to 0.5%; or
Fe total (expressed as Fe₂O₃) in amounts of 0,002 to 0.06% and CeO₂ in amounts of 0.001 to 1%; or
Fe total (expressed as Fe₂O₃) in amounts of 0,002-0.06%; and one of the following components:
manganese (calculated as MnO) in an amount ranging from 0.01 to 1% by weight;
antimony (expressed as Sb₂O₃), in an amount ranging from 0.01 to 1% by weight;
arsenic (expressed as As₂O₃), in an amount ranging from 0.01 to 1% by weight, or
copper (expressed as CuO), in an amount ranging from 0.0002 to 0.1% by weight.

These types of glass having high transmission in the infrared are well known by the skilled person and need not be further described herein. Alternatives may exist, which may be suitable in the scope of the present invention, provided the absorption coefficient is <25 m⁻¹, as discussed above.

The first glass pane may thus be selected from infrared transmissive glass, for its long term resistance to exposure, its color stability and its low impact on the environment in terms of usage and recycling. The added advantage of glass is that the thickness of the sheet of glass may be tuned to reduce the overall weight of the pane.

The first glass may further be characterized by any one or more of the following characteristics, for a glass sheet of 4 mm thickness:
25%<TE<50%
Tᵥᵢₛ/TE<0.30; alternatively <0.20
Tᵥᵢₛ*TE/T_{IR}<3

In preferred embodiments, the first pane is the outer pane of the composite pane.

In such preferred embodiments, the first pane having such a low visible transmittance has the advantage that it alleviates the need for enamel coating in P2, since it is sufficiently dark to hide any border or edge defects, such as bubbles, or undesired optical reflection effects of the borders of the composite pane. Such alleviation of enamel also allows for an homogeneous TTS across the entire surface of the composite pane. Since there is no reduction of the infrared reflectivity function of the at least one infrared reflective coating in the (absent) enamel area, the thermal comfort is not disrupted at the edges of the composite pane.

Also, when the outer glass pane is such a high infrared transmissive glass sheet, the at least one infrared reflective coating present in the composite pane may be fully efficient in reflecting heat rays (infrared rays), such that heat is not absorbed within the glass sheet or within the composite pane, and thermal management is optimized.

The second glass pane may specifically be characterized by a ratio Tvis/TIR>0.50, and by a ratio Tvis/TE>0.70, for a glass sheet of 4 mm thickness (with TIR considered in the wavelengths of 780-2500 nm, and Tvis considered in the wavelengths of 380-780 nm, and TE considered in the wavelength range of 300-2500 nm).

The second glass pane may be a clear or colored glass of soda-lime-silica, aluminosilicate or borosilicate type, and the like.

A colored second glass pane may be a regular colored glass substrate, such as green, grey, bronze, or blue-green glass substrates.

The ratio Tᵥᵢₛ/T_{IR} of the second glass pane may preferably be >0.70, more preferably >0.90.

In some first instances, compatible with the above preferred embodiments, the second pane may further be characterized by a visible transmission Tvis>65% (in the wavelengths of 380-780 nm) and a transmitted energy TE>35%, for a glass sheet of 4 mm thickness.

The second pane, in these first instances, may further be characterized by any one or more of the following characteristics, for a glass sheet of 4 mm thickness:
30%<TE<92%
Tᵥᵢₛ*TE/T_{IR}>80

The combination of the at least one infrared reflective coating with such a second pane characterized by a visible transmission Tᵥᵢₛ>65% as inner pane in the installed position, allows for a reduced light reflectance to the outside, with values Rout≤7%, lower than the initial values of Rout≤9%.

In some second instances, compatible with the above preferred embodiments, the second pane may further be characterized by an infrared transmission TIR<25% (in the wavelengths of 780-2500 nm) and a visible transmission Tvis ranging of from 3 to 65% (in the wavelengths of 380-780 nm), for a glass sheet of 4 mm thickness. Such glass may also be referred to as “colored glass”.

The second pane, in these second instances, may further be characterized by any one or more of the following characteristics, for a glass sheet of 4 mm thickness:
2%<TE<25%
5<Tᵥᵢₛ*TE/T_{IR}<80

The combination of the at least one infrared reflective coating with such a second pane having a visible transmission Tᵥᵢₛ ranging of from 3 to 65% as inner pane, allows for a reduced light reflectance to the outside, with values Rout≤7%, together with a reduced light reflectance to the inside, with values Rin≤6%, irrespective of the type of selected infrared reflective coating.

The additional advantage of the selection of the second and inner glass pane as a so-called colored glass, is the tuning of the overall light transmittance of the composite pane and the reduction of the interior reflection.

The second glass pane may thus be selected from clear or colored glass, with ranges of light transmittance in the visible of >65% (first instances) or Tvis ranging from 3 to 65% (second instances), for their color stability and their low impact on the environment in terms of usage and recycling and ease of manufacture. The added advantage of glass is that the thickness of the sheet of glass may be tuned to reduce the overall weight of the pane.

The glass panes may independently be annealed, tempered or heat strengthened.

The outer and inner panes may independently have a thickness ranging from 0.5 mm to 15 mm, alternatively from 0.5 mm to 10 mm, alternatively from 0.5 mm to 8 mm, alternatively from 0.5 mm to 6 mm.

The outer and inner panes in the present composite pane may have a thickness ranging from 0.5 to 4 mm.

Both panes may have the same thickness, for example 0.5 mm, or 0.8 mm, or 1.2 mm, or 1.6 mm, or 2.1 mm, or 3 mm. Such symmetrical construction in glass thickness allows for ease of process and conventional sizing of the laminating process.

Both panes may also have different thicknesses, providing for asymmetrical laminated glazings, for example pane 1=0.5 mm and pane 2=2.1 mm, or pane 1=0.8 mm and pane 2=2.1 mm, or pane 1=0.5 mm and pane 2=1.6 mm, pane 1=0.8 mm and pane 2=1.6 mm, or pane 1=1.6 mm and pane 2=2.1 mm. Such asymmetrical constructions in glass thickness allow for flexibility in curvature, and/or in weight management and/or flexibility in light/solar modulation.

A preferred construction may be provided when the outer glass sheet is thicker than the inner glass sheet, for reasons of mechanical stability of the composite pane, and possibly to improve the overall total transmitted heat radiation (TTS), for example, the outer glass pane may be 2.1 mm thick, while the inner glass pane may be 1.6 mm thick.

The terms “polymer interlayer sheet,” “interlayer,” “interlayer” as used herein, generally may designate a single-layer sheet or a multilayered interlayer. A “single-layer sheet,” as the name implies, is a single or monolithic thermoplastic layer extruded as one layer which is then used to laminate two panes. A multilayered interlayer, on the other hand, may comprise multiple layers, including separately extruded layers, co-extruded layers, or any combination of separately and co-extruded layers of thermoplastic material. Thus a multilayered interlayer could comprise, for example: two or more single-layer sheets combined together (“plural-layer sheet”); two or more layers co-extruded together (“co-extruded sheet”); two or more co-extruded sheets combined together; a combination of at least one single-layer sheet and at least one co-extruded sheet; a combination of at least one plural-layer sheet and at least one co-extruded sheet, or any other combination of sheets as desired.

Typical materials for the thermoplastic interlayer include, but are not limited to, polyvinyl acetal, polyvinyl butyral, polyurethane, poly(ethylene-co-vinyl acetate), polyvinylchloride, poly(vinylchloride-co-methacrylate), polyethylenes, polyolefins, ethylene acrylate ester copolymers, poly(ethylene-co-butyl acrylate), silicone elastomers, epoxy resins, and acid copolymers, and, in general, any optical bonding material with refractive index between 1.4 and 1.7.

The thermoplastic interlayer preferably contain polyvinyl butyral (PVB), ethylene vinyl acetate (EVA), polyurethane (PU) and/or mixtures thereof and/or copolymers thereof, particularly preferably polyvinyl butyral.

The thermoplastic interlayer are preferably based on the materials mentioned but may, however, contain other components, for example, plasticizers, photophores, heat insulating particles, infrared absorbing particles, polymer-dispersed liquid crystals, suspended particles, pigments, colorants, or UV absorbers, preferably with a content of less than 50%.

The thermoplastic interlayer preferably is clear and colorless, and has a light transmittance>50%, preferably >60%, more preferably >75%, as measured by Illuminant A, with a 2° observer in an installed position between two sheets of clear float glass of 2.1 mm.

The use of a clear and colorless thermoplastic interlayer allows for the final composite pane to work with most common thermoplastic interlayer with regards to cost and recyclability (measured with Illuminant A, 2°). Such optimal thermoplastic interlayer may be characterized by a Tvis≥80%, as measured between 2 sheets of clear float glass of 2.1 mm, preferably Tvis≥ 84%, or more preferably, Tvis≥89%.

The individual thermoplastic film layer preferably have a thickness of about 0.2 mm to 1 mm, for example, 0.38 mm or 0.76 mm.

The at least one infrared (IR) reflective coating and the low emissivity coating of the present invention are provided as thin film coatings, having each independently a thickness ranging from 10 to 1000 nm.

When discussing the infrared reflective coating and the low emissivity coating in the present invention, it is typically understood that the layers are numbered in sequence starting from the substrate surface. That is, a first layer is understood to be the first applied on the substrate, a second being the second layer applied on the substrate, above the first layer. The successive order of the positions is considered relative to the substrate onwards, up to the uppermost layer.

In the scope of the present invention, the terms “below”, “underneath”, “under” indicate the relative position of a layer vis a vis a next layer, within the layer sequence starting from the substrate. In the scope of the present invention, the terms “above”, “upper” indicate the relative position of a layer vis a vis a next layer, within the layer sequence starting from the substrate.

In the scope of the present invention, the relative positions of the layers within the stack do not necessarily imply direct contact between the layers. That is, some interlayer may be provided between the first and second layer. For example, a first layer “deposited over” the substrate does not preclude the presence of one or more other coating layers of the same or different composition located between that first layer film and the substrate, provided the objective of the present invention is not jeopardized.

In some instances, a layer may actually be composed of several multiple individual (sub) layers.

Unless stated otherwise, all layer thicknesses herein are geometrical layer thicknesses.

According to the invention, an IR reflective coating is present between the outer pane and the inner pane. The role of such an IR reflective coating is to reflect the infrared portions of the solar radiation passing through the outer pane, and to reduce the heat transfer towards the inner pane and interior of the vehicle.

As discussed above, the IR reflective coating being in the path of the external heat rays before arriving to the inner pane, said inner pane is prevented from heat load.

The at least one IR reflective coating may be embedded in the thermoplastic interlayer, or be applied directly on the interior-side surface of the outer pane.

When the IR reflective coating is embedded in the thermoplastic interlayer, the IR reflective coating is typically applied on a carrier film that is arranged between two thermoplastic films. Such an embedded IR reflective coating may be selected from non-metallic solar control films also known as multilayer optical films or laminated structures of interference polymer layers, where the layers have different refractive index characteristics so that some light is reflected at interfaces between adjacent layers; or from metallic solar control film.

The carrier film preferably contains polyethylene terephthalate (PET) and has a thickness of 0.012 to 0.2 mm. such coatings are well known in the art and need not be further described herein.

In preferred embodiments, compatible with other preferred embodiments, the at least one IR reflective coating is applied directly on the interior-side surface of the outer pane. Such positioning allows for optimal interference with the external heat rays, before even penetrating the thermoplastic interlayer, such that the majority of the heat is reflected out, through the outer pane. Both the inner pane and the thermoplastic interlayers are so protected from heat load.

When the IR reflective coating is applied on a surface of a pane, facing the thermoplastic interlayer, it is typically provided by physical vapor deposition methods.

Such a IR reflective coating applied on a surface of a pane may comprise n infrared reflective (IR) layers and n+1 dielectric layers, with n≥1, such that each IR layer is surrounded by two dielectric layers.

Such IR reflective coating preferably comprises n infrared reflective (IR) layers and n+1 dielectric layers, with n>1, such that each IR layer is surrounded by two dielectric layers. Such IR reflective coating offers an optimal comprise between sun protection efficiency and cost.

The IR reflective layer may be made of silver, gold, palladium, platinum or alloys thereof.

The IR reflective layer or functional layer may have a thickness from 2 to 35 nm, alternatively from 5 to 25 nm, alternatively from 7 to 18 nm. These thickness ranges may enable the desired solar control function and/or conductivity (when needed) to be achieved.

The dielectric layers may typically comprise oxides, nitrides, oxynitrides or oxycarbides of Zn, Sn, Ti, Zr, Si, In, Al, Bi, Ta, Hf, Mg, Nb, Y, Ga, Sb, Mg, Cu, Ni, Cr, Fe, V, B or mixtures thereof.

In certain embodiments of the present invention, the dielectric layers may comprise oxides, nitrides, oxynitrides or oxycarbides of Zn, Sn, Ti, Zr, Si, In, Al, Nb, Sb, Ni, Cr, V, Mb, Mg or mixtures thereof. Alternatively, the dielectric layers may comprise oxides, nitrides, oxynitrides of Zn, Sn, Ti, Zr, Si, In, Al, Nb, Sb, Ni, Cr, or mixtures thereof.

These materials may optionally be doped, where examples of dopants include aluminum, zirconium, silicon, niobium, boron, or mixtures thereof. The dopant or mixture of dopants may be present in an amount up to 15 wt %.

Typical examples of dielectric materials include, but are not limited to, silicon based oxides, silicon based nitrides, zinc oxides, aluminum doped zinc oxides, zinc-based oxides, tin oxides, mixed zinc-tin oxides, silicon nitrides, silicon oxynitrides, titanium oxides, aluminum oxides, zirconium oxides, niobium oxides, aluminum nitrides, bismuth oxides, mixed silicon-zirconium nitrides, and mixtures of at least two thereof, such as for example titanium-zirconium oxides, titanium-niobium oxides, zinc-titanium oxides, zinc-gallium oxides, zinc-indium-gallium oxides (IGZO), zinc-titanium-aluminum oxides (ZTAO), zinc-tin-titanium oxides, zinc-aluminum-vanadium oxides, zinc-aluminum-molybdenum oxides, zinc-aluminum-magnesium oxides, zinc-aluminum-chromium oxides, zinc-aluminum-copper oxides, zinc-titanium-zirconium oxides.

Each dielectric layer may consist of a plurality of individual layers comprising or essentially consisting of the above materials.

The dielectric layers may each have a thickness ranging from 0.1 to 200 nm, alternatively from 0.1 to 150 nm, alternatively from 1 to 120 nm, alternatively from 1 to 90 nm. Different dielectric layers may have different thicknesses. That is, the first dielectric layer may have a thickness that is the same or different, greater or smaller, compared to the thickness of the second or third or any other dielectric layer.

Preferred IR reflective coating may typically comprise at least one infrared reflective layer embedded between dielectric layers comprising several layers, among which layers of varying composition in zinc oxide, that is, layers of zinc oxide, zinc oxide doped with aluminum, or layers of mixed oxide of zinc and tin, having a ratio Sn/Zn ranging from 0.5 to 2 by weight, or having a ratio Sn/Zn ranging from 0.02 to 0.5 by weight; layers of silicon nitride; layers of titanium oxide; layers of silicon nitride; layers of mixed oxide of zinc, titanium and aluminum, among others. In some instances, the IR layer(s) may be independently provided with a metallic barrier layer such as Ti, Ni, NiCr, NiCrW, Zr, or the like.

The preferred IR reflective coating may typically comprise a topcoat providing for mechanical and chemical durability selected from titanium oxide, zirconium oxide, silicon nitride, silicon oxide, mixed oxide of titanium and zirconium, mixed oxide of silicon and zirconium, or mixed nitride of silicon and zirconium, and mixtures or alloys thereof.

Such preferred IR reflective coatings have shown particularly good compatibility with the thermoplastic intermediate layer comprising at least 10% of recycled material, while displaying efficiency in protection of the thermoplastic interlayer from sun rays.

Examples suitable IR reflective coating include those coatings comprising: a dielectric layer; a first barrier layer (seed layer); an infrared (IR) reflective layer comprising silver; a second barrier layer and another dielectric layer, wherein the dielectric layers may be selected from zinc oxide, silicon nitride or mixtures thereof. The barriers may be selected from Ni, Cr, W, Ti, or any mixture or alloy thereof. Such a coating may also comprise more than one IR reflective layer.

Further suitable examples of IR reflective coating include a solar control coating comprising
a base dielectric layer comprising at least a base dielectric lower layer and a base dielectric upper layer which is of a different composition to that of the base dielectric lower layer, the base dielectric upper layer comprising either one of zinc oxide or a mixed oxide of Zn and at least one additional material X, in which the ratio X/Zn in the base dielectric upper layer is between 0.02 and 0.5 by weight and in which X is one or more of the materials selected from the group comprising Sn, Al, Ga, In, Zr, Sb, Bi, Mg, Nb, Ta and Ti,
a first infra-red reflecting layer, such as silver, gold, platinum, or mixtures thereof,
a first barrier layer,
a central dielectric layer comprising at least a central dielectric lower layer and a central dielectric upper layer which is of a different composition to that of the central dielectric lower layer, the central dielectric lower layer being in direct contact with the first barrier layer and the central dielectric upper layer; the central dielectric upper layer comprising either one of zinc oxide or a mixed oxide of Zn and at least one additional material Y, in which the ratio Y/Zn in the base dielectric upper layer is between 0.02 and 0.5 by weight and in which Y is one or more of the materials selected from the group comprising Sn, Al, Ga, In, Zr, Sb, Bi, Mg, Nb, Ta and Ti,
a second infra-red reflecting layer, such as silver, gold, platinum, or mixtures thereof,
a second barrier layer,
a top dielectric layer.

A still further example of suitable IR reflective coating includes a solar control coating comprising
a base dielectric layer comprising at least a base dielectric lower layer and a base dielectric upper layer which is of a different composition to that of the base dielectric lower layer, the base dielectric upper layer comprising either one of zinc oxide or a mixed oxide of Zn and at least one additional material X, in which the ratio X/Zn in the base dielectric upper layer is between 0.02 and 0.5 by weight and in which X is one or more of the materials selected from the group comprising Sn, Al, Ga, In, Zr, Sb, Bi, Mg, Nb, Ta and Ti,
a first infra-red reflecting layer, such as silver, gold, platinum, or mixtures thereof,
a first barrier layer,
a second dielectric layer comprising at least a second dielectric lower layer and a second dielectric upper layer which is of a different composition to that of the second dielectric lower layer, the second dielectric lower layer being in direct contact with the first barrier layer and the second dielectric upper layer; the second dielectric upper layer comprising either one of zinc oxide or a mixed oxide of Zn and at least one additional material Y, in which the ratio Y/Zn in the second dielectric upper layer is between 0.02 and 0.5 by weight and in which Y is one or more of the materials selected from the group comprising Sn, Al, Ga, In, Zr, Sb, Bi, Mg, Nb, Ta and Ti,
a second infra-red reflecting layer, such as silver, gold, platinum, or mixtures thereof,
a second barrier layer,
a third dielectric layer comprising at least a third dielectric lower layer and a third dielectric upper layer which is of a different composition to that of the third dielectric lower layer, the third dielectric lower layer being in direct contact with the second barrier layer and the third dielectric upper layer; the third dielectric upper layer comprising either one of zinc oxide or a mixed oxide of Zn and at least one additional material Y, in which the ratio Y/Zn in the third dielectric upper layer is between 0.02 and 0.5 by weight and in which Y is one or more of the materials selected from the group comprising Sn, Al, Ga, In, Zr, Sb, Bi, Mg, Nb, Ta and Ti,
a third infra-red reflecting layer, such as silver, gold, platinum, or mixtures thereof,
a third barrier layer,
a top dielectric layer.

In such examples of IR reflective coatings, the base dielectric upper layer may be in direct contact with the first infra-red reflecting layer. The central dielectric upper layer may be in direct contact with the second infra-red reflecting layer. The upper layers of both the base dielectric layer and the central, first and second dielectric layer may independently have a geometrical thickness within the range of about 3 to 20 nm. One or both of the additional materials X and Y may be Sn and/or Al. The proportion of Zn in the mixed oxide that forms the base dielectric upper layer and/or that which forms the central dielectric upper layer may be such that ratio X/Zn and/or the ratio Y/Zn is between about 0.03 and 0.3 by weight. The first and/or second and/or third barrier layer may be a layer comprising Ti and/or comprising an oxide of Ti, and they may each independently have a geometrical thickness of from 0.5 to 7 nm. The base dielectric upper layer and/or the central and/or the second and/or third dielectric upper layer may independently have a geometrical thickness<20 nm, alternatively <15 nm, alternatively <13 nm, alternatively <11 nm, and >3 nm, alternatively >5 nm, alternatively >10 nm. The infra-red reflecting layers may each independently have a thickness of from 2 to 22 nm, alternatively of from 5 to 20 nm, alternatively of from 8 to 18 nm. The top dielectric layer may comprise at least one layer which comprises a mixed oxide of Zn and at least one additional material W, in which the ratio W/Zn in that layer is between 0.02 and 2.0 by weight and in which W is one or more of the materials selected from the group comprising Sn, Al, Ga, In, Zr, Sb, Bi, Mg, Nb, Ta and Ti. A topcoat may be present selected from titanium oxide, zirconium oxide, silicon nitride, silicon oxide, mixed oxide of titanium and zirconium, mixed oxide of silicon and zirconium, or mixed nitride of silicon and zirconium, and mixtures or alloys thereof.

The IR reflective coating may be an electrically conductive coating such as an electrically conductive heated window coating or a single-film or multi-film coating capable of functioning as an antenna.

According to embodiments of the invention, compatible with the above embodiments, an optional low emissivity coating may be present on the interior-side of the inner pane (side 4). Such low emissivity coating reflects thermal radiation, i.e., in particular, IR radiation of longer wavelength than the IR component of solar radiation. At low outside temperatures, the low emissivity coating reflects heat back into the interior and reduces the cooling of the interior. At high outside temperatures in the summer, the low emissivity coating on the interior side of the inner pane reduces the emission of thermal radiation from the pane into the interior while it reduces the emission of heat into the external environment in the winter.

In the present invention, since heat rays are reflected back from the IR reflecting coating through the outer pane, the inner pane suffers less from heat load, such that the optional low emissivity coating is mostly present to ensure the thermal comfort and to allows for the maintenance of the temperature within the interior space.

The optional low emissivity coating comprises at least one functional layer that contains a transparent conductive oxide (TCO), selected from indium tin oxide, antimony-doped or fluorine-doped tin oxide, gallium- and/or aluminum-doped zinc oxide, mixed indium zinc, vanadium oxide, tungsten and/or magnesium doped vanadium oxide, niobium-doped titanium oxide, and/or cadmium stannate; or at least one nitride based functional layer with low emissivity properties selected from titanium nitride, chromium nitride, niobium nitride, molybdenum nitride, hafnium nitride, or mixtures thereof.

Preferred transparent conductive oxide (TCO) may be selected from indium tin oxide, antimony-doped or fluorine-doped tin oxide and/or aluminum-doped zinc oxide (ZnO:Al) and/or gallium-doped zinc oxide (ZnO:Ga), with indium tin oxide or fluorine-doped tin oxide most preferred.

Preferred nitride based functional layer may be selected from titanium nitride or chromium nitride, or mixtures thereof.

The refractive index of the material of the TCO functional layer is preferably 1.7 to 2.5.

The emissivity of the pane can be influenced by the thickness of the functional layer of the low emissivity coating. The thickness of the at least one functional layer may range of from 45 nm to 210 nm, preferably 90 nm to 175 nm, and most preferably 105 nm to 170 nm. This range allows for an optimal compromise between a low emissivity and thermal treatment resistance of the pane.

In the scope of the present invention, the low emissivity coating may be characterized by an emissivity<0.2 (according to the standard EN 12898).

A first suitable optional low emissivity coating includes a coating comprising the following layers, in sequence: a first low refractive index layer, for example silicon oxide, and a transparent conductive oxide layer.

This first suitable low emissivity coating allows to reach a light reflectance inside the vehicle, Rin, <10% or even <8%.

In a second suitable optional low emissivity coating, the at least one TCO functional layer may be surrounded by dielectric layers which may have alternating low and high refractive indices. In particular, the first dielectric layer, that is, the layer under the TCO functional layer, may comprise a first sublayer of high refractive index material, and subsequently, a second sublayer of low refractive index material. The second dielectric layer, that is, the layer above the TCO functional layer, may comprise a third sublayer of high refractive index material, and subsequently, a fourth sublayer of low refractive index material.

Examples of high refractive index dielectric layers, that is, with a refractive index>1.7, alternatively >1.8, include zirconium doped titanium dioxide, silicon doped titanium dioxide, mixed oxide of zinc and tin, mixed oxide of titanium and silicon.

Examples of low refractive index dielectric layers, that is, with a refractive index≤1.6, alternatively ≤1.55, include silicon oxide, zirconium doped silicon oxide, mixed oxide of silicon and aluminum, magnesium fluoride.

An optimal optional low emissivity coating includes a coating comprising the following layers, in sequence: a first high refractive index layer, a first low refractive index layer, a transparent conductive oxide layer, an optional barrier layer, a second low refractive index layer, and an optional top coat having a low refractive index.

The first high refractive index layer may have a thickness ranging of from 7 to 23 nm, alternatively of from 8 to 20 nm, alternatively of from 9 to 19 nm.

The first low refractive index layer may have a thickness ranging of from 18 to 55 nm, alternatively of from 20 to 50 nm, alternatively of from 25 to 45 nm.

The transparent conductive oxide layer may have a thickness ranging of from 75 to 210 nm, alternatively of from 90 to 175 nm, alternatively of from 105 to 170 nm.

The optional barrier layer may have a thickness ranging of from 0 to 15 nm, alternatively of from 1 to 15 nm, alternatively of from 1 to 12 nm.

The second low refractive index layer may have a thickness ranging of from 40 to 110 nm, alternatively of from 45 to 105 nm, alternatively of from 50 to 95 nm.

The optional top coat may have a thickness ranging of from 2 to 40 nm, alternatively of from 5 to 35 nm, alternatively of from 6 to 30 nm.

The optional topcoat may be a layer of silicon oxide comprising zirconium in an amount of 5 to 40 mol % and/or 0.2 to 3.0 at %. Such an uppermost layer allows for tuning the neutral color rendering of the low emissivity coating together with superior durability, for example against scratches. Indeed, the low emissivity coating being positioned towards the passenger compartment, it may be subject to wear and scratches from cleaning or passenger occupations. Such passenger occupations may impact the integrity of the coating, such as rubbing or objects, (umbrellas, balls, clothes, etc.). This uppermost layer may also provide compatibility and adhesion to the fastening elements which will subsequently be used to secure the composite pane within a vehicle frame.

An optimal optional low emissivity coating may thus include a coating comprising the following layers, in sequence: a first high refractive index layer having a thickness ranging of from 7 to 23 nm, a first low refractive index layer having a thickness ranging of from 18 to 55 nm, a transparent conductive oxide layer having a thickness ranging of from 75 to 210 nm, an optional barrier layer having a thickness ranging of from 0 to 15 nm, a second low refractive index layer having a thickness ranging of from 40 to 110 nm, and an optional top coat having a low refractive index having a thickness ranging of from 2 to 40 nm.

Typically, a pane of clear float glass (soda-lime glass) provided with such an optimal low emissivity coating may have a light transmittance of 85 to 94%.

The present optional optimal low emissivity coating may be characterized by an emissivity≤0.35, preferably ≤0.25 (according to the standard EN 12898).

A composite pane according to embodiments of the present invention comprising a combination of an inner glass pane characterized by an infrared transmission TIR<25% (in the wavelengths of 780-2500 nm) and a visible transmission Tvis ranging of from 3 to 65% (in the wavelengths of 380-780 nm) and a transmitted energy TE ranging of from 2 to 25%, for a glass sheet of 4 mm thickness, with a low emissivity coating allows to reach a very low light reflectance inside the vehicle, with values of Rin<4%.

In absence of a low emissivity coating, the present composite pane may reach a total transmitted heat radiation (TTS)≤22%. This TTS value can be reduced in presence of a low emissivity coating as herein described, to values≤16%.

Yet another example of suitable optional low emissivity coating may be a low emissivity coating comprising at least two layers of transparent electrically conductive oxide having each a thickness ranging from 20 to 80 nm, which are separated by at least one layer of dielectric material. Such a low emissivity coating may thus comprise n′ TCO layers and n′+1 dielectric layers, with n′≥1, such that each IR layer is surrounded by two dielectric layers. Examples of dielectric layers for such a suitable low emissivity coating include silicon oxide, silicon nitride, zinc oxide, tin oxide, titanium oxide, or alloys or mixtures thereof.

Further suitable optional low emissivity coatings include those comprising at least one conductive nitride. Such a low emissivity coating may comprise at least one functional layer comprising a metal nitride, a crystallinity-improving layer comprising ZrNₓ, wherein x is higher than 1.2 and at most 2.0, present below and in contact with the metal nitride layer. The ratio of the thickness of the functional layer to the thickness of the crystallinity-improving layer may advantageously be from 5 to 10.

Another suitable low emissivity coating may comprise, in sequence starting from the substrate surface:
a first dielectric layer having a thickness of from 1.5 to 200 nm,
a first crystallinity-improving layer having a thickness of from 3 to 30 nm,
a first metal nitride functional layer having a thickness of from 3 to 60 nm, and
a second dielectric layer having a thickness of from 1.5 to 200 nm,
optionally followed by a second crystallinity-improving layer, a second metal nitride functional layer, and a third dielectric layer,
   wherein the crystallinity-improving layers comprise ZrNx, wherein x is higher than 1.2 and at most 2.0, and the metal nitride functional layers are selected from the group consisting of titanium nitride, chromium nitride, niobium nitride, molybdenum nitride and hafnium nitride and may have a thickness ranging from 3 to 60 nm and the first, second and/or third dielectric layers may have a thickness ranging from 1.5 to 2000 nm and advantageously comprise silicon nitride doped with aluminum.

A low emissivity coating comprising a metal nitride functional layer may further comprise a toplayer comprising silicon dioxide, titanium nitride and/or carbon.

The composite pane is obtained through typical methods to provide for laminated composite panes.

The deposition of the optional low emissivity coating on the inner pane (P4), and/or the deposition of the at least one infrared reflective coating on a glass may be independently carried out by using a method selected among CVD, PECVD, PVD, magnetron sputtering, or the like.

Different layers of the respective coatings may be deposited using different techniques.

When indium tin oxide is used, it is preferably deposited by means of magnetron-enhanced cathodic sputtering with a target of indium tin oxide. The target preferably contains from 75 wt.-% to 95 wt.-% indium oxide and from 5 wt.-% to 25 wt.-% tin oxide as well as production-related admixtures. The deposition of the indium tin oxide or tin-doped indium oxide is preferably done under a non-reactive gas atmosphere, for example, argon. A small amount of oxygen can also be added to the non-reactive gas, for example, to improve the homogeneity of the functional layer.

Alternatively, the target can preferably contain at least from 75 wt. % to 95 wt. % indium and from 5 wt. % to 25 wt. % tin. The deposition of the indium tin oxide is preferably done under addition of oxygen as the reactive gas during cathodic sputtering.

The at least one infrared reflective coating may be arranged on a carrier film embedded in the interlayer, such as discussed above.

The glass panes provided with the respective coatings may subsequently be subjected to a thermal treatment, to reinforce the glass panes, and to optimize performances of said coatings.

The thermal treatments comprise heating the glazing to a temperature of at least 560 °C in air, for example between 560 °C and 700 °C, in particular around 630 °C to 670 °C, during around 3, 4, 6, 8, 10, 12 or even 15 minutes according to the heat-treatment type and the thickness of the glazing. The treatment may comprise a rapid cooling step after the heating step, to introduce a stress difference between the surfaces and the core of the glass so that in case of impact, the so-called tempered glass sheet will break safely in small pieces. If the cooling step is less strong, the glass will then simply be heat-strengthened and in any case offer a better mechanical resistance.

The assembling of the inner and outer panes with the thermoplastic interlayer may be a lamination step for flat glass, or may be a bending step for curved laminated glass, which bending step includes the steps of first bending the sheets of glass and second, laminating said bent sheets of glass.

In some instances, when the at least one infrared reflective coating is present on a carrier film embedded in the thermoplastic interlayer, it is assembled with the inner and outer panes during the lamination step.

The composite pane may also be subject to enamel deposition and/or preparation for inclusion within a frame.

The composite pane therefore is targeted to possess the following characteristics:
a light transmittance Tvis of 1 to 10%, preferably of 1 to 8%, in order to ensure the best possible compromise between vision outside through the composite pane and good thermal properties;
a light reflectance observed from the outside Rout≤9%;
a light reflectance observed from the inside Rin≤10%;
a low total transmitted heat radiation (TTS)≤22%, preferably ≤16%, (measured according to ISO 9050).

The present composite pane may thus be characterized by a light transmittance of 1 to 10%, preferably of 1 to 8%, which ensures the best possible compromise between vision outside through the composite pane and good thermal properties.

This light transmittance may be reached by the selection of the appropriate inner and outer panes.

A first suitable construction comprises a second pane as outer pane, having an outer-side surface and an interior-side surface, characterized by a ratio Tvis/TIR>0.50, and by a ratio Tvis/TE>0.70, for a glass sheet of 4 mm thickness (with TIR considered in the wavelengths of 780-2500 nm, and Tvis considered in the wavelengths of 380-780 nm, and TE considered in the wavelength range of 300-2500 nm), and a first pane as inner pane, having an outer-side surface and an interior-side surface, characterized by an infrared transmission T_{IR}>60% (in the wavelengths of 780-2500 nm) and a visible transmission Tᵥᵢₛ<10%, alternatively ≤6% (in the wavelengths of 380-780 nm), and a ratio Tᵥᵢₛ/T_{IR}<0.20, for a glass sheet of 4 mm thickness.

A second suitable construction comprises a first pane as outer pane, having an outer-side surface and an interior-side surface, characterized by an infrared transmission T_{IR}>60% (in the wavelengths of 780-2500 nm) and a visible transmission Tᵥᵢₛ<10%, alternatively ≤6% (in the wavelengths of 380-780 nm), and a ratio Tᵥᵢₛ/T_{IR}<0.20, for a glass sheet of 4 mm thickness, and a second pane as inner pane, having an outer-side surface and an interior-side surface, characterized by a ratio Tᵥᵢₛ/T_{IR}>0.50, and by a ratio Tᵥᵢₛ/TE>0.70, for a glass sheet of 4 mm thickness (with T_{IR} considered in the wavelengths of 780-2500 nm, and Tᵥᵢₛ considered in the wavelengths of 380-780 nm, and TE considered in the wavelength range of 300-2500 nm).

A third suitable construction comprises a first pane as outer pane, having an outer-side surface and an interior-side surface, characterized by a infrared transmission T_{IR}>60% (in the wavelengths of 780-2500 nm) and a visible transmission Tᵥᵢₛ<10%, alternatively ≤6% (in the wavelengths of 380-780 nm), and a ratio Tᵥᵢₛ/T_{IR}<0.20, for a glass sheet of 4 mm thickness and a second pane as the inner glass pane further characterized by a visible transmission Tᵥᵢₛ>65% (in the wavelengths of 380-780 nm) and a transmitted energy TE>35%, for a glass sheet of 4 mm thickness.

A fourth and optimal construction comprises a first pane as outer pane, having an outer-side surface and an interior-side surface, characterized by a infrared transmission T_{IR}>60% (in the wavelengths of 780-2500 nm) and a visible transmission Tᵥᵢₛ<10%, alternatively <6% (in the wavelengths of 380-780 nm), and a ratio Tᵥᵢₛ/T_{IR}<0.20, for a glass sheet of 4 mm thickness and a second pane as the inner glass pane further characterized by an infrared transmission T_{IR}<25% (in the wavelengths of 780-2500 nm) and a visible transmission Tᵥᵢₛ ranging of from 3 to 65% (in the wavelengths of 380-780 nm), for a glass sheet of 4 mm thickness.

The combination of a high infrared transmissive outer glass pane and the IR reflective coating inserted between the outer and inner pane, and preferably positioned on the interior-side of the outer pane (P2), allows to reach a light reflectance observed from the outside Rout<7%.

The proper selection of the colored inner glass pane allows to reach a light reflectance observed from the inside Rin<6%, which can be further reduced in presence of a low emissivity coating positioned on the inner-side of said colored inner pane to values of Rin<4%, or Rin≤3%, or even Rin≤2%, depending on the selected type of low emissivity coating.

The low emissivity coating, positioned on the inner-side of the colored inner pane (P4), towards the vehicle compartment, together with good durability, allows to further reduce the TTS to values less or equal to 16%.

The present invention also relates to the use of the composite pane according to the invention as a window pane of a vehicle.

A vehicle includes those vehicles useful for transportation on road, in air, in and on water, in particular cars, busses, tramways, trains, ships, aircraft, spacecraft, space stations and other motor vehicles.

The window panes include rear window, side windows, sun roof, panoramic roof or any other window useful for a car, or any glazing for any other transportation device, where light transmittance>70% is not a mandatory feature. Preferably, the window pane may be a lateral window, a rear window or a roof window.

The window pane most preferably is a roof panel of a vehicle, in particular a passenger car, as it may best provide for solar control over a wide surface as compared to side windows.

Such a composite pane for use as window pane or roof is favored by the low total transmitted heat radiation (TTS) of less or equal to 22%, preferably less or equal to 16%, (measured according to ISO 9050).

The present pane may be also be useful in architectural applications. Architectural applications include displays, windows, doors, partitions, shower panels, and the like.

In some instances, the composite pane may serve as a heatable vehicle glazing.

In the following, the invention is explained in detail with reference to drawings and exemplary embodiments. The drawings are schematic representations and not to scale. The drawings in no way restrict the invention.

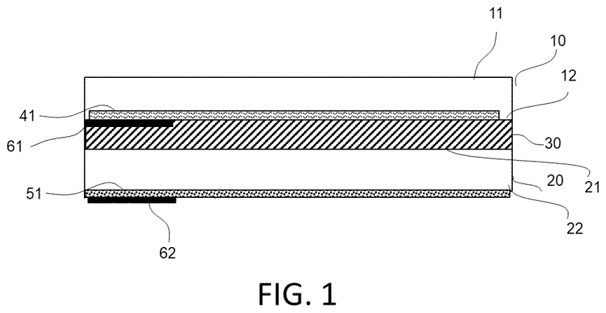

FIG. 1 depicts a cross-section through an embodiment of the composite pane according to the invention. The composite pane comprises an outer pane 10 and an inner pane 20 that are joined to one another via a thermoplastic interlayer 30. The composite pane may for example have a size of approximately 1 m² and is intended for use as a roof panel of a passenger car, with the outer pane 10 intended to face the external environment and the inner pane 20 intended to face the vehicle interior. The outer pane 10 has an outer-side surface 11 and an interior-side surface 12. The inner pane 20 has an outer-side surface 21 and an interior-side surface 22. The outer-side surface 11 and 21 face the external environment in the installed state; the interior-side surfaces 12 and 22 face the vehicle interior in the installed position. The interior-side surface 12 of the outer pane 10 and the outer-side surface 21 of the inner pane 20 face one another, and are bound by the thermoplastic interlayer 30. The outer pane 10 and the inner pane 20 may be provided as discussed above. In some embodiments of the invention, they may each have a thickness of 2.1 mm, or the one pane may have a thickness of 1.6 mm, and the other pane may have a thickness of 2.1 mm.

The thermoplastic interlayer 30 may generally have a thickness of 0.76 mm.

In FIG. 1, an IR reflective coating 41 is arranged on the interior-side surface 12 of the outer pane 10. The IR reflective coating 41 may extend over the entire surface 12, or may extend over the entire surface minus a circumferential frame-shaped coating-free region. The coating-free region is hermetically sealed by bonding with the thermoplastic interlayer 30. The IR reflective coating 41 is thus advantageously protected against damage and corrosion. The IR reflective coating 41 comprises, for example, at least two functional layers that at least contain silver or are made of silver and have a layer thickness between 5 nm and 20 nm, with each functional layer arranged between two dielectric layers made of the materials listed above, related to the IR reflective coating.

A low emissivity coating 52 may be optionally arranged on the interior-side surface 22 of the inner pane 20. The coating 52 may be an optimal low emissivity coating discussed above.

Enamel coatings or dark prints 61 and 62 may be provided as obscuration bands typically present on vehicle glazings, intended to be mounted on a vehicle frame. Typical fastening methods may be employed to secure the composite pane on a vehicle.

### EXAMPLES

Various composite panes were prepared according to the invention and their properties were evaluated.

The assessment of the characteristics of the glass panes and of the composite panes were carried out according to automotive reference ISO9050, under Illuminant A, at a 2° observer:
Tvis (%): light transmittance in the visible range of 380-780 nm
TIR (%): infrared transmittance in the infrared range of 780-2500 nm
TE (%); energy transmittance in the wavelength range of 300-2500 nm
TTS (%): total transmitted heat radiation in the wavelength range of 300-2500 nm.
Rout (%): light reflectance to the outside in the visible range of 380-780 nm
Rin (%): light reflectance to the inside in the visible range of 380-780 nm

The outer and inner glass sheets have the characteristics as outlined in Table 1 below, for glass sheets of 4 mm thickness.

The first panes, or Infrared transmissive glass panes, are referred to as “IR”, namely IR-1 to IR-4, each characterized by a infrared transmission T_{IR}>60% (in the wavelengths of 780-2500 nm) and a visible transmission Tᵥᵢₛ<10%, alternatively ≤6% (in the wavelengths of 380-780 nm), and a ratio Tᵥᵢₛ/T_{IR}<0.20, for a glass sheet of 4 mm thickness.

The second panes characterized by a ratio Tvis/TIR>0.50, and by a ratio Tvis/TE>0.70, for a glass sheet of 4 mm thickness (with TIR considered in the wavelengths of 780-2500 nm, and Tvis considered in the wavelengths of 380-780 nm, and TE considered in the wavelength range of 300-2500 nm) include Clear glass panes, referred to as Clear-1 and Clear-2, and colored glass panes referred to as “CG” for colored glass, namely CG-1 to CG-4.

Clear float glass, referred to as Clear-1 and Clear-2, and CG-4 are further characterized by a visible transmission Tvis>65% (in the wavelengths of 380-780 nm) and a transmitted energy TE>35%, for a glass sheet of 4 mm thickness.

CG-1 to CG-3 are further characterized by an infrared transmission TIR<25% (in the wavelengths of 780-2500 nm) and a visible transmission Tvis ranging of from 3 to 65% (in the wavelengths of 380-780 nm) and a transmitted energy TE ranging of from 2 to 25%, for a glass sheet of 4 mm thickness.

TABLE 1

| Glass | Tvis | TIR | TE | Tvis/TIR | Tvis/TE | Tvis*TE/TIR | L* | a* | b* |
|---|---|---|---|---|---|---|---|---|---|
| IR-1 | 3.0 | 74.9 | 37.3 | 0.04 | 0.08 | 1.5 | 19.7 | −0.9 | 3.0 |
| IR-2 | 1.8 | 65.0 | 34.1 | 0.03 | 0.05 | 1.0 | 17.7 | −17.2 | −9.8 |
| IR-3 | 1.8 | 65.2 | 34.2 | 0.03 | 0.05 | 0.9 | 17.5 | −17.2 | −9.8 |
| IR-4 | 1.1 | 77.1 | 37.3 | 0.01 | 0.03 | 0.5 | 5.6 | 22.9 | −1.7 |
| CG-1 | 7.6 | 8.9 | 8.6 | 0.85 | 0.88 | 7.4 | 32.9 | −0.6 | 1.7 |
| CG-2 | 17.3 | 16.1 | 17.2 | 1.07 | 1.01 | 18.4 | 48.6 | −1.0 | −0.1 |
| CG-3 | 31.9 | 7.4 | 17.9 | 4.32 | 1.78 | 77.5 | 65.1 | −15.7 | 0.4 |
| CG-4 | 71.1 | 23.2 | 44.1 | 3.06 | 1.61 | 135.1 | 88.4 | −8.3 | 2.1 |
| Clear 1 | 89.6 | 81.5 | 84.8 | 1.10 | 1.06 | 93.2 | 95.9 | −0.8 | 0.5 |
| Clear 2 | 89.7 | 91.8 | 90.5 | 0.98 | 0.99 | 88.4 | 95.9 | −0.9 | 0.6 |

The infrared (IR) reflective coatings were chosen from standard silver-based coatings comprising 2 or 3 silver layers embedded in dielectric layers comprising sublayers of zinc oxide having varying compositions.

The coatings referred to as Ag2a (2 silver layers) and Ag3 (3 silver layers) are typically used in applications requiring light transmittance above 70%, therefore, these coatings have a light transmittance on clear glass of 2.1 mm=72-75%. The IR reflective coating Ag2b was specially designed to reach for low solar energy transmission, as compared to standard IR reflective coating Ag2a typically used in windshields, such that its light transmittance on clear glass of 2.1 mm=47%.

The details of the stacks “Ag2a” and “Ag2b” are provided in Table 2

Materials are as follows: ZSO=zinc-tin mixed oxide provided from a metallic target comprising Zn at 52 wt % and Sn at 48 wt %; ZnO=zinc oxide with aluminium dopant; Ag=silver; Ti=titanium; TiO2=titanium dioxide.

TABLE 2

| Physical thickness | | | | | | | | | | | | |
|---|---|---|---|---|---|---|---|---|---|---|---|---|
| (nm) - Sequence from glass | ZSO5 | ZnO | Ag | Ti | ZnO | ZSO5 | ZnO | Ag | Ti | ZnO | ZSO5 | TiO2 |
| Ag2a | 16.5 | 10.0 | 9.2 | 0.4 | 1.0 | 77.0 | 10.0 | 13.1 | 0.4 | 0.5 | 13.5 | 5.0 |
| Ag2b | 22.0 | 10.0 | 9.9 | 0.4 | 1.0 | 95.0 | 10.0 | 26.0 | 2.3 | 0.5 | 24.2 | 5.0 |

The thermoplastic interlayer was a clear and colorless PVB sheet of 0.76 mm, having a light transmittance of 90% when measured between 2 sheets of clear glass (FCLO in Table 1) of 2.1 mm, commercialized under the trade name Eastman® RF 41.

The optional low emissivity coating (Low e) was as indicated in Table 3. Materials are as follows: TiZrO=titanium zirconium mixed oxide; SiO2=silicon dioxide; InSnOx=indium tin mixed oxide; SiZrOx=silicon oxide with zirconium dopant.

TABLE 3

| sequence from glass | TiZrOx | SiO2 | InSnOx | SiO2 | SiZrOx |
|---|---|---|---|---|---|
| Refractive index | 2.35 | 1.47 | 1.85 | 1.47 | 1.54 |
| Physical thickness (nm) | 14 | 35 | 136 | 77 | 17 |

### Results

The various composite panes were assembled and their properties evaluated as provided in Table 4.

The thicknesses of the glass sheets used in the examples were either 2.1 mm or 1.6 mm, and are indicated for each respective example.

Comparative composite panes were also provided. Comparative example 1 was provided according to pending application PCT/EP2023/054315 with two sheets of clear float glass and a grey colored interlayer, said grey colored interlayer having a light transmittance of 1.5% and a thickness of 0.76 mm.

Comparative example 2 was provided with a colored outer pane having a Tvis of 71.1%, free of IR reflective coating and an infrared transmissive inner pane IR-4.

Comparative example 3 was provided with an infrared transmissive outer pane IR-4, free of IR reflective coating, and a clear inner pane having a Tvis of 85.6%.

Example 1 was provided with an outer sheet of clear glass (characterized by a visible transmission Tvis>65% (in the wavelengths of 380-780 nm) and a transmitted energy TE>35%, for a glass sheet of 4 mm thickness) provided with an IR reflective coating comprising 3 silver layers, and inner sheet of infrared transmissive inner pane IR-4.

Examples 2 to 4 were provided with an outer sheet of infrared transmissive inner pane IR-4 and inner panes characterized by a visible transmission Tvis>65% (in the wavelengths of 380-780 nm) and a transmitted energy TE>35%, for a glass sheet of 4 mm thickness-Clear and CG-4.

Examples 5 to 8 were provided with an outer sheet of infrared transmissive inner pane IR-4 and inner panes characterized by an infrared transmission TIR<25% (in the wavelengths of 780-2500 nm) and a visible transmission Tvis ranging of from 3 to 65% (in the wavelengths of 380-780 nm) and a transmitted energy TE ranging of from 2 to 25%, for a glass sheet of 4 mm thickness. The composite panes of Examples 5 to 8 also comprised an IR reflective coating in P2 and a low emissivity coating as per Table 3, in P4.

Examples 9 to 14 were provided with an outer sheet of infrared transmissive inner pane IR-1 and inner panes characterized by an infrared transmission TIR<25% (in the wavelengths of 780-2500 nm) and a visible transmission Tvis ranging of from 3 to 65% (in the wavelengths of 380-780 nm) and a transmitted energy TE ranging of from 2 to 25%, for a glass sheet of 4 mm thickness. The composite panes of Examples 9 to 14 also comprised an IR reflective coating in P2. A low emissivity coating as per Table 3 was present in the composite panes, in P4, of Examples 9 to 13 and not in Example 14.

Examples 15 to 20 were provided with an outer sheet of infrared transmissive inner pane IR-2 or IR-3 and inner panes characterized by an infrared transmission TIR<25% (in the wavelengths of 780-2500 nm) and a visible transmission Tvis ranging of from 3 to 65% (in the wavelengths of 380-780 nm) and a transmitted energy TE ranging of from 2 to 25%, for a glass sheet of 4 mm thickness. The composite panes of Examples 15 to 20 also comprised an IR reflective coating in P2. A low emissivity coating as per Table 3 was present in the composite panes, in P4, of Examples 15 to 17 and 19, but not in Examples 18 and 20.

Examples 21 and 22 were provided with an outer sheet of infrared transmissive inner pane IR-1 and inner panes characterized by an infrared transmission TIR<25% (in the wavelengths of 780-2500 nm) and a visible transmission Tvis ranging of from 3 to 65% (in the wavelengths of 380-780 nm) and a transmitted energy TE ranging of from 2 to 25%, for a glass sheet of 4 mm thickness. The composite panes of Examples 21 and 22 comprised the AG2b IR reflective coating in P2, contrary to Example 12 which comprised AG2a IR reflective coating in P2. A low emissivity coating as per Table 3 was present in the composite panes, in P4.

TABLE 4

| | Glass | (mm) | P2 | Glass | (mm) | P4 | Tvis | Rout | Rin | TTS | TE |
|---|---|---|---|---|---|---|---|---|---|---|---|
| Comparative 1 | Clear-1 | 2.1 | Ag2a | Clear-1 | 1.6 | LOW E | 1.3 | 12.4 | 1.7 | 11.2 | 1.7 |
| Comparative 2 | CG-4 | 2.1 | — | IR-4 | 2.1 | LOW E | 6.6 | 4.3 | 1.8 | 29.3 | 16.9 |
| Comparative 3 | IR-4 | 2.1 | — | Clear-1 | 2.1 | LOW E | 7.6 | 4.3 | 1.8 | 41.3 | 31.5 |
| Example 1 | Clear-2 | 2.1 | Ag3 | IR-4 | 2.1 | LOW E | 5.7 | 8.3 | 1.8 | 11.4 | 3.8 |
| Example 2 | IR-4 | 2.1 | Ag2 | Clear-1 | 2.1 | LOW E | 6.3 | 4.3 | 9.0 | 18.6 | 9.5 |
| Example 3 | IR-4 | 2.1 | Ag3 | Clear-1 | 2.1 | LOW E | 6.0 | 4.3 | 5.3 | 13.5 | 4.1 |
| Example 4 | IR-4 | 2.1 | Ag2a | CG-4 | 2.1 | LOW E | 5.5 | 4.3 | 7.5 | 15.7 | 5.9 |
| Example 5 | IR-4 | 2.1 | Ag2a | CG-1 | 2.1 | LOW E | 1.7 | 4.3 | 2.3 | 13.1 | 2.8 |
| Example 6 | IR-4 | 2.1 | Ag2a | CG-1 | 1.6 | LOW E | 2.3 | 4.3 | 2.8 | 13.9 | 3.8 |
| Example 7 | IR-4 | 1.6 | Ag2a | CG-1 | 2.1 | LOW E | 3.0 | 4.5 | 2.3 | 13.6 | 3.7 |
| Example 8 | IR-4 | 2.1 | Ag3 | CG-3 | 2.1 | LOW E | 3.3 | 4.3 | 3.0 | 11.7 | 1.9 |
| Example 9 | IR-1 | 2.1 | Ag3 | CG-3 | 2.1 | LOW E | 6.9 | 4.4 | 3.0 | 12.9 | 3.2 |
| Example 10 | IR-1 | 2.1 | Ag2a | CG-2 | 2.1 | LOW E | 5.2 | 4.5 | 3.1 | 15.6 | 5.5 |
| Example 11 | IR-1 | 2.1 | Ag3 | CG-2 | 2.1 | LOW E | 5.0 | 4.4 | 2.4 | 12.6 | 2.8 |
| Example 12 | IR-1 | 2.1 | Ag2a | CG-1 | 2.1 | LOW E | 3.4 | 4.5 | 2.3 | 14.2 | 3.8 |
| Example 13 | IR-1 | 2.1 | Ag3 | CG-1 | 2.1 | LOW E | 3.3 | 4.4 | 2.0 | 11.8 | 1.9 |
| Example 14 | IR-1 | 2.1 | Ag3 | CG-1 | 2.1 | NO LOW E | 3.2 | 4.4 | 4.6 | 18.0 | 1.9 |
| Example 15 | IR-3 | 2.1 | Ag2a | CG-1 | 2.1 | LOW E | 2.4 | 4.4 | 2.3 | 15.1 | 4.1 |
| Example 16 | IR-3 | 1.6 | Ag2a | CG-1 | 2.1 | LOW E | 3.8 | 4.6 | 2.3 | 15.4 | 4.9 |
| Example 17 | IR-2 | 2.1 | Ag3 | CG-3 | 2.1 | LOW E | 4.9 | 4.4 | 3.0 | 13.4 | 3.0 |
| Example 18 | IR-2 | 2.1 | Ag3 | CG-3 | 2.1 | NO LOW E | 4.9 | 4.4 | 5.5 | 19.8 | 3.1 |
| Example 19 | IR-3 | 2.1 | Ag3 | CG-3 | 2.1 | LOW E | 4.8 | 4.4 | 3.0 | 13.3 | 3.0 |
| Example 20 | IR-3 | 2.1 | Ag3 | CG-3 | 2.1 | NO LOW E | 4.8 | 4.4 | 5.5 | 19.7 | 3.1 |
| Example 21 | IR-1 | 2.1 | Ag2b | CG-1 | 2.1 | LOW E | 1.5 | 5.8 | 5.6 | 12.5 | 2.1 |
| Example 22 | IR-1 | 2.1 | Ag2b | CG-1 | 2.1 | LOW E | 2.0 | 5.4 | 4.7 | 12.2 | 2.0 |

Comparative example 1 provided with both outer and inner sheets of clear glass did not achieve a light reflectance observed from the outside (Rout) less than 9%.

Comparative examples 2 and 3, free of IR reflective coating, did not achieve a total transmitted heat radiation (TTS) less than 20%.

Example 1 achieved
a light transmittance Tvis of 1 to 10%,
a light reflectance observed from the outside Rout≤9%;
a light reflectance observed from the inside Rin≤10%;
a total transmitted heat radiation (TTS)≤22%.

Examples 2 to 4 achieved
a light transmittance Tvis of 1 to 10%,
a light reflectance observed from the outside Rout≤7%, even ≤6%;
a light reflectance observed from the inside Rin≤10%;
a total transmitted heat radiation (TTS)≤22%.

Examples 5 to 8, 9 to 13, 15 to 17 and 19, provided with a low emissivity coating, achieved
a light transmittance Tvis of 1 to 10%,
a light reflectance observed from the outside Rout≤7%, even ≤6%;
a light reflectance observed from the inside Rin≤8% and even ≤6%;
a total transmitted heat radiation (TTS)≤16%, or even ≤14%.

Examples 14, 18 and 20, free of a low emissivity coating, achieved
a light transmittance Tvis of 1 to 10%,
a light reflectance observed from the outside Rout≤7%, even ≤6%;
a light reflectance observed from the inside Rin≤8% and even ≤6%;
a total transmitted heat radiation (TTS)≤22%.

Examples 21 and 22, provided with a low emissivity coating and with the specifically designed Ag2b IR reflective coating, achieved
a light transmittance Tvis of 1 to 10%, for example of 1 to 2%,
a light reflectance observed from the outside Rout≤7%, even ≤6%;
a light reflectance observed from the inside Rin≤8% and even ≤6%;
a total transmitted heat radiation (TTS)≤16%, or even <13%.

Due to the specifically designed AG2b IR reflective coating, the values reached by Examples 21 and 22 were similar to the values of Example 13 comprising Ag3 IR reflective coating in terms of total transmitted heat radiation (TTS), with a reduced light transmittance Tvis but higher light reflectance to the outside or inside. The thicker second silver layer manages to achieve very good solar control performances and lower light transmittance, with a more simple design than triple silver coatings. The same or similar results may be achieved with a thicker first silver layer. Such specifically designed coatings are even more suitable for vehicle roof applications.

The composite panes provided with a low emissivity coating according to Examples 1 to 13, 15 to 17 and 19 may be characterized by a transmittance index A≤0.02, the transmittance index A being determined according to the following formula (I)=TL_{composite glass pane}/(TL_{low-E-coated pane}*TE) (I), TL being the light transmittance and TE being the energy transmission measured according to ISO 9050, according to WO2019/110172A.

1. A composite pane, comprising:
a. a first glass pane having an outer-side surface and an interior-side surface, having an infrared (IR) transmission T_{IR}>60%, in a wavelength range of 780-2500 nm, and a visible transmission Tᵥᵢₛ<10%, in a wavelength range of 380-780 nm, and a ratio Tᵥᵢₛ/T_{IR}<0.20, for a glass sheet of 4 mm thickness;
b. a second glass pane having an outer-side surface and an interior-side surface, different from the first pane, having a ratio Tvis/TIR>0.50, and a ratio Tvis/TE>0.70, for a glass sheet of 4 mm thickness, with TIR considered in a wavelength range of 780-2500 nm, and Tvis considered a wavelength range of 380-780 nm, and TE considered in a wavelength range of 300-2500 nm; and
c. a thermoplastic interlayer that joins an interior-side surface of an outer pane to an outer-side surface of an inner pane,
wherein the composite pane comprises, between the outer pane and the inner pane, at least one infrared (IR) reflective coating.

2. The composite pane according to claim 1, wherein, when the second glass pane is the inner pane of the composite pane in an installed position, the second glass pane has a visible transmission Tvis>65%, in a wavelength range of 380-780 nm, and a transmitted energy TE>35%, for a glass sheet of 4 mm thickness.

3. The composite pane according to claim 1, wherein the second glass pane has any one or more of the following characteristics, for a glass sheet of 4 mm thickness:
30%<TE<92%
Tvis*TE/TIR>80.

4. The composite pane according to claim 1, wherein, when the second glass pane is the inner pane of the composite pane in an installed position, the second glass pane has an infrared transmission TIR<25%, in a wavelength range of 780-2500 nm, and a visible transmission Tvis range of 3 to 65%, in a wavelength range of 380-780 nm, for a glass sheet of 4 mm thickness.

5. The composite pane according to claim 1, wherein the second glass pane has any one or more of the following characteristics, for a glass sheet of 4 mm thickness:
2%<TE<25%
5<Tvis*TE/TIR<80.

6. The composite pane according to claim 1, wherein the first glass pane is further characterized by any one or more of the following characteristics, for a glass sheet of 4 mm thickness:
25%<TE<50%
Tvis/TE<0.30;
Tvis*TE/TIR<3.

7. The composite pane according to claim 1, further comprising a low emissivity coating on the interior-side surface of the inner pane.

8. The composite pane according to claim 7, wherein the low emissivity coating comprises at least one functional layer that contains a transparent conductive oxide (TCO), selected from the group consisting of indium tin oxide, antimony-doped or fluorine-doped tin oxide, gallium- and/or aluminum-doped zinc oxide, mixed indium zinc, vanadium oxide, tungsten and/or magnesium doped vanadium oxide, niobium-doped titanium oxide, cadmium stannate and/or zinc stannate; or at least one nitride based functional layer with low emissivity properties selected from titanium nitride, chromium nitride, niobium nitride, molybdenum nitride hafnium nitride, and mixtures thereof.

9. The composite pane according to claim 7, wherein the low emissivity coating comprises at least one functional layer that contains a transparent conductive oxide (TCO), selected from the group consisting of indium tin oxide, antimony-doped or fluorine-doped tin oxide and/or aluminum-doped zinc oxide (ZnO: Al) and gallium-doped zinc oxide (ZnO:Ga).

10. The composite pane according to claim 7, wherein the low emissivity coating comprises layers in the following sequence: a first high refractive index layer, a first low refractive index layer, a transparent conductive oxide layer, an optional barrier layer, a second low refractive index layer, and an optional top coat having a low refractive index.

11. The composite pane according to claim 1, wherein the at least one IR reflective coating is applied directly to the interior-side surface of the outer pane or is arranged on a carrier film embedded in the thermoplastic interlayer.

12. The composite pane according to claim 1, wherein the IR reflective coating comprises n infrared (IR) reflective layers and n+1 dielectric layers, with n≥1, such that each IR reflective layer is surrounded by two dielectric layers.

13. The composite pane according to claim 1, wherein the IR reflective coating comprises n infrared (IR) reflective layers and n+1 dielectric layers, with n≥2, such that each IR reflective layer is surrounded by two dielectric layers.

14. The composite pane according to claim 1, wherein the thermoplastic interlayer contains polyvinyl butyral (PVB), copolymers of vinyl ethylene and vinyl acetate (EVA), polyurethane (PU), polyvinyl chloride (PVC), and/or mixtures thereof and/or copolymers thereof.

15. A vehicle comprising the composite pane according to claim 1, as a window pane.

16. The composite pane according to claim 15, wherein the window pane is a lateral window, a rear window or a roof window.

17. The composite pane according to claim 1, wherein the first glass pane has a visible transmission Tᵥᵢₛ<6% in a wavelength range of 380-780 nm.

18. The composite pane according to claim 1, wherein the first glass pane has by any one or more of the following characteristics, for a glass sheet of 4 mm thickness:
25%<TE<50%
Tvis/TE<0.20
Tvis*TE/TIR<3.
